(19) United States
(12) Patent Application Publication
(10) Pub. No.: US 2020/0159485 A1
(43) Pub. Date: May 21, 2020

(54) VIRTUAL REALITY REAL-TIME VISUAL NAVIGATION METHOD AND SYSTEM

(71) Applicant: Alex Chien-Hua Lee, Taipei City (TW)

(72) Inventors: Derek Chiu, Taipei City (TW); Alex Chien-Hua Lee, Taipei City (TW)

(21) Appl. No.: 16/750,188

(22) Filed: Jan. 23, 2020

Related U.S. Application Data
(63) Continuation of application No. 15/927,974, filed on Mar. 21, 2018.
Application No. 15/927,974 is a continuation of application No. 15/587,415, filed on May 5, 2017, now abandoned.

(30) Foreign Application Priority Data
May 30, 2016 (TW) 105116854
Dec. 12, 2016 (TW) 105141076

(51) Int. Cl. G06F 3/14; G06F 3/147; G06F 3/01

(52) U.S. Cl. CPC G06F 3/1454; G06F 3/011; G06F 3/147

(57) ABSTRACT

A virtual reality real-time visual navigation method and system includes at least one reality display device and a visual navigation control interface connected to the reality display device. A user may play a virtual reality display screen after wearing the reality display device, and the electronic device has a visual navigation control interface including at least one user screen display area for synchronously displaying a virtual reality display screen played by each reality display device to facilitate a commentator to make a narration through the screen and let users understand more easily.

This application is a continuation of the earlier U.S. Utility patent application entitled “VIRTUAL REALITY REAL-TIME VISUAL NAVIGATION METHOD AND SYSTEM,” Ser. No. 15/927,974, filed Mar. 21, 2018 which is a continuation of U.S. patent application entitled “VIRTUAL REALITY REAL-TIM VISUAL NAVIGATION METHOD AND SYSTEM,” Ser. No. 15/587,415, filed May 5, 2017, which claims priority to TW 105141076 filed Dec. 12, 2016 which is a divisional of TW 105116854 filed May 30, 2016 the disclosures of which are hereby incorporated entirely herein by reference.

### FIELD OF THE INVENTION

The present invention relates to the technical field of a virtual reality real-time visual navigation method and system, particularly to the method and system capable of immediately confirming the position of a screen viewed by a user.

### BACKGROUND OF THE INVENTION

### 1. Description of the Related Art

As technology advances, visual virtual reality becomes a main research and development subject for related manufacturers. At present, the application of such virtual reality technology is just popular in movies at present.

Most of the present house purchases uses photos to let homebuyers to know the house condition instead of taking some time on transportation to visit and watch the house or even taking the whole day to visit many houses. Since the homebuyers have to go to houses at different locations, it will take more time on transportation. Therefore, it is a main issue for the real estate companies to let homebuyers have the same feeling of watching the actual house without going to the site.

In addition, many places such as tourist attractions, hotels or museums have the same problems. Although virtual reality technology can solve a part of the problem, yet it requires further improvements to let users understand the space or characteristics better. Therefore, finding a way for consumers to have the feeling of being at site and solve any doubts immediately demands immediate attention and feasible solutions.

### 2. Summary of the Invention

In view of the aforementioned drawbacks, the inventor of the present invention based on years of experience in the related industry to collect information, conduct evaluation and extensive experiments, and finally designed and developed the virtual reality real-time visual navigation method and system to overcome the drawbacks of the prior art.

To achieve the aforementioned and other objectives, the present invention provides a virtual reality real-time visual navigation method, transmitting data through a reality display device, an electronic device and a server, characterized in that the reality display device receives an image of one of a plurality of locations stored in the server from the server and performs a virtual reality play, and synchronously displays a screen displayed by the reality display device on the electronic device, and the electronic device simultaneously performs a signal connection with the plurality of reality display devices, while displaying a screen displayed by the connected reality display devices, wherein the electronic device has a visual navigation control interface installed thereto and capable of controlling a location displayed by the reality display devices.

In the aforementioned method, users may use the reality display device to watch an image at a location while another operator may use the screen displayed by the electronic device to understand the screen watched by the users, so as to synchronously narrate or response to users.

In addition, the screens have at least one hot point set thereon, and a user may jump to an image of a related location by selecting the hot point by the reality display device or the electronic device. With this method, users may intuitively understand the direction of the related locations and users may associate with the overall geographical direction and position quickly.

In addition, the reality display device includes a focus detection module installed thereto and provided for detecting a focus watched by a user's eye and displaying a focus position on a screen displayed by the electronic device. Therefore, the operator may understand the object discussed by the user and reduce miscommunications.

The present invention further provides a reality display device including a focus detection module installed therein, and at least one reality display device coupled to the electronic device, and at least one user screen display area of the visual navigation control interface has a focus mark, and the focus detection module is provided for detecting a focal position of a user's eyes, and the focus mark is used at the focal position of the user's eyes in the user screen display area, so that a commentator can know the position at where the user is watching to facilitate the corresponding narration, and such arrangement not just facilitates the commentator's narration only, but also gives the user a feeling of being situated at the site.

The present invention further provides a reality display device for playing a virtual reality display screen, and at least one predetermined position of the virtual reality display screen has a sub-screen switching area, and the electronic device coupled to at least one reality display device has a sub-screen hot point sign in at least one user screen display area of the visual navigation control interface and configured to be corresponsive to the sub-screen switching area of the virtual reality display screen, so that the commentator knows that there is a sub-screen switching area in advance, and the sub-screen hot point sign allows the sub-screen display area to display sub-screen related data, so as to provide a better narration to users. Such arrangement not just makes the narration better only, but also lets the users have a feeling of actually visiting the place and makes the commentator more professional.

The present invention further provides a reality display device for playing a virtual reality display screen, and an electronic device coupled to at least one reality display device and provided for synchronously displaying a virtual reality display screen played by each reality display device in at least one user screen display area of the visual navigation control interface, so that a commentator may perform a narration corresponding to a user's watching area and position, and the users may have a feeling of personally visiting the site.

The present invention further provides a visual navigation control interface of the electronic device having a plurality of user screen display areas, and the commentator may move the screen to watch the virtual reality display screens watched by different users or use at least one switching key to switch the virtual reality display screen watched by different users, and the commentator may perform the narration to a plurality of users at the same time.

### BRIEF DESCRIPTION OF THE DRAWINGS

FIG. 1 is a system block diagram view of a preferred embodiment of the present invention;

FIG. 2 is a schematic view of a display screen of a reality display device of a preferred embodiment of the present invention;

FIG. 3 is a system block diagram view of a preferred embodiment of the present invention;

FIG. 4 is a system block diagram view of a preferred embodiment of the present invention;

FIG. 5 is a schematic view of a display screen of a reality display device of a preferred embodiment of the present invention;

FIGS. 6 and 7 are schematic view of setting a hot point of a preferred embodiment of the present invention;

FIG. 8 is a schematic view of a set hot point of a preferred embodiment of the present invention; and

FIG. 9 is a schematic view of generating a QR code of a preferred embodiment of the present invention.

### DESCRIPTION OF THE PREFERRED EMBODIMENTS

The above and other objects, features and advantages of this disclosure will become apparent from the following detailed description taken with the accompanying drawings.

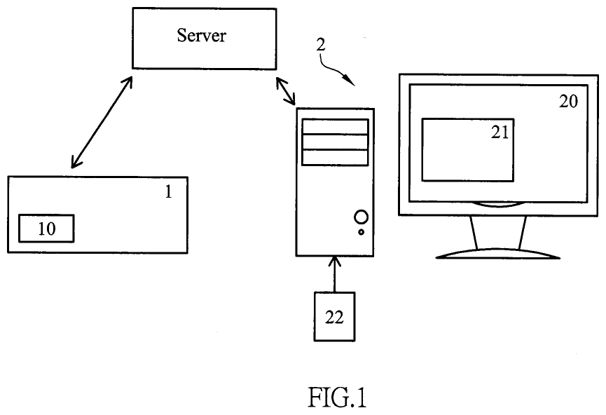

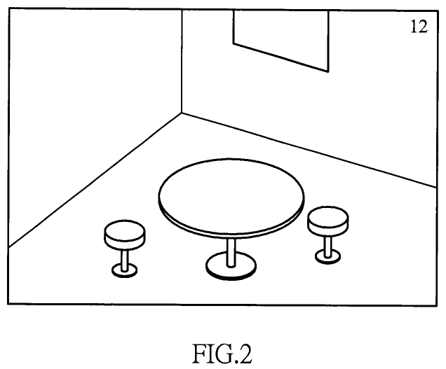

With reference to FIGS. 1, 2 and 3 for the present invention, the present invention comprises at least one reality display device 1 and an electronic device 2, and the reality display device 1 and the electronic device 2 perform data transmission with a server. In addition, the reality display device 1 further comprises a loudspeaker 10, and each reality display device 1 plays a virtual reality display screen 12, and the electronic device 2 has a visual navigation control interface 20, and the visual navigation control interface 20 has at least one user screen display area 21 for synchronously displaying a virtual reality display screen 12 displayed by each reality display device 1, and the electronic device 2 includes a microphone 22 and a camera, and the electronic device 2 may be a computer, a mobile phone or a tablet PC, and the visual navigation control interface 20 may be a computer software or a mobile application program (APP). In addition, the reality display device 1 may be a head mount virtual reality device, a mobile phone, or a tablet PC.

The virtual reality real-time visual navigation system of the present invention may be used in the areas of watching/buying houses, tours, museum visits or recreation area narrations, and buying/watching houses is used as an example for illustrating the present invention, but the invention is not limited to such application only.

During use, the virtual reality real-time visual navigation system has a reality display device 1 that can be worn by a user, so that the user can watch the virtual reality display screen 12, and the commentator can watch the visual navigation control interface 20 of the electronic device 2 having the user screen display area 21. Since each virtual reality display screen 12 and the corresponding user screen display area 21 display the same screen, therefore the commentator can know the area and position at where the user is watching, and perform the narration directly to the user, or the commentator can capture audio data through the microphone 22 and transmit the audio data to the reality display device 1, and the loudspeaker 10 plays the audio data to let the user listen to the commentator's talk. As a result, the user and the commentator can save transportation time without visiting the actual scene personally, and a single commentator can simultaneously serve a plurality of users arriving at different time. Obviously, the invention is very convenient.

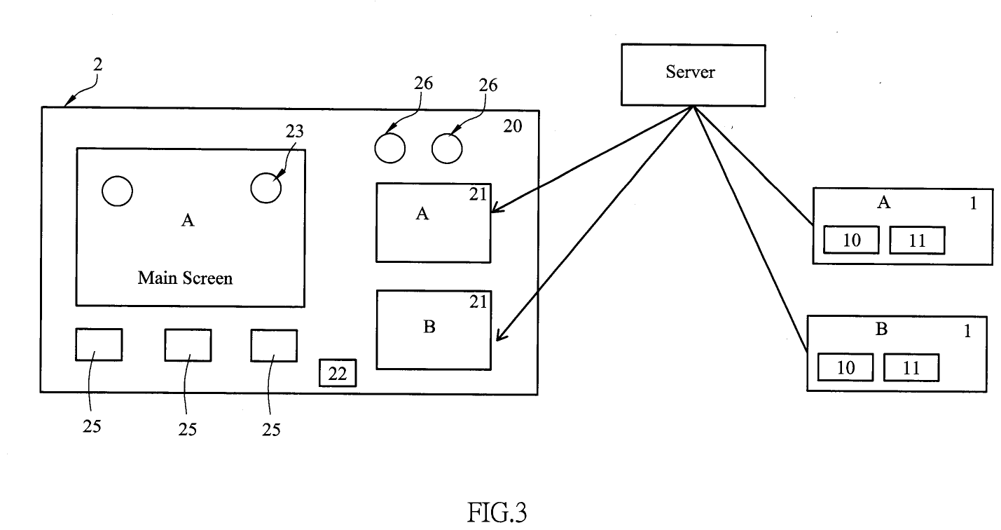

With reference to FIG. 3, the present invention comprises at least one reality display device 1 and an electronic device 2, wherein the at least one reality display device 1 includes a loudspeaker 10 and a focus detection module 11, and each reality display device 1 plays a virtual reality display screen 12, and the at least one reality display device 1 is coupled to the electronic device 2, and the electronic device 2 has a visual navigation control interface 20, and the visual navigation control interface 20 has at least one user screen display area 21 for synchronously displaying the virtual reality display screen 12 played by each reality display device 1, and each user screen display area 21 has a focus mark 211 in a cross shape, a T-shape, an eye shape, a circular shape or any other shape, and the electronic device 2 has a microphone 22.

When the user wears the reality display device 1, the user may walk freely in the house to watch different positions, electric appliances or decorations. Now, the focus detection module 11 is provided for detecting a focus position of the user's eyes and transmitting the focus position to the electronic device 2, so that a focus mark 211 is displayed in the user screen display area 21 of the visual navigation control interface 20 and at a position corresponsive to the focal position of the user's eyes. Therefore, the commentator can know the position, electric appliance or decoration at where the user is watching and perform the corresponding narration at the same time, so as to achieve the effect of facilitating the commentator to conduct the narration, and the user has the feeling of actually being at the site. In the meantime, the reality display device screen or the screen displayed by the electronic device may display another user representative icon entering into the same scene, and the user representative icons will be displayed on the screen according to the connected coordinates. Therefore, the commentator can know whether there are other people watching, and these icons give the information of the place where other people are watching and allow the commentator to control the whole situation. The method of detecting the focus position assumes that the eyes are looking at the center of the screen, so that the center point of the screen watched by the user is the detected focus, or a camera is installed at the top of the reality display device and faces the user, and the camera is provided for detecting and confirming the position where the eyeball is rotating in order to obtain the focus of the eyeball.

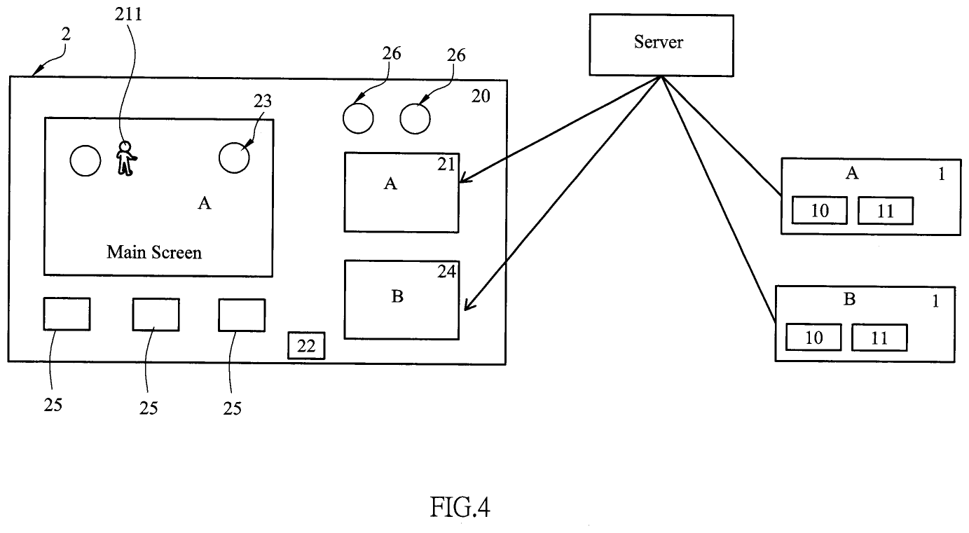

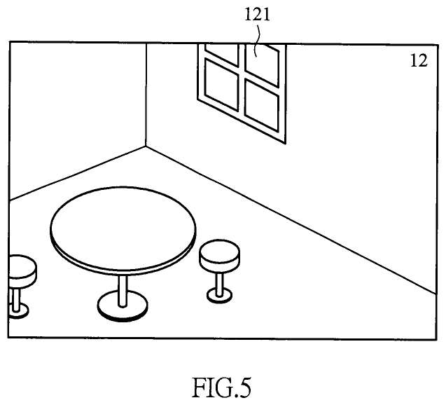

With reference to FIGS. 4 and 5, the present invention comprises at least one reality display device 1 and an electronic device 2, wherein the at least one reality display device 1 has a loudspeaker 10 and a focus detection module 11, and each reality display device 1 plays a virtual reality display screen 12, and at least one predetermined position of the virtual reality display screen 12 has a sub-screen switching area 121, and the at least one reality display device 1 is coupled to the electronic device 2, and the electronic device 2 has a visual navigation control interface 20, and the visual navigation control interface 20 has at least one user screen display area 21 for synchronously displaying a virtual reality display screen 12 played by each reality display device 1, and each user screen display area 21 has a focus mark 211, and the electronic device 2 has a microphone 22, and the visual navigation control interface 20 has a sub-screen hot point sign 212 disposed in the at least one user screen display area 21 and configured to be corresponsive to the sub-screen switching area 121 of the virtual reality display screen 12.

The at least one predetermined position of the virtual reality display screen 12 played by each reality display device 1 has a sub-screen switching area 121 (such as a window, a door, or a balcony of a house). When the user moves into the sub-screen switching area 121, a corresponsive sub-screen is displayed, and the user screen display area 21 watched by the commentator has a sub-screen hot point sign 212 set in the corresponsive sub-screen switching area 121, so that before the user has moved into the sub-screen switching area 121, the commentator can click the sub-screen hot point sign 212 to display the corresponsive sub-screen related data in the sub-screen display area 24 in advance and perform the narration to users. Since houses have different layouts, furnishings and decorations, therefore the corresponsive rooms or views outside the window are different. The commentator can know related corresponsive information in advance to give a complete narration, allow the users to have a better feeling of visiting user, and make the commentator more understandable and professional.

Each user screen display area 21 may have a sub-screen hot point sign 212, or at least one hot point key 2 disposed on a side of each user screen display area 21, and at least one sub-screen display area 24 disposed on a side of each user screen display area 21, so that the commentator may click the sub-screen hot point sign 212, or click the hot point key 2 of each sub-screen hot point sign 212 in order to display corresponsive sub-screen related data in the sub-screen display area 24.

With reference to FIGS. 3, 4 and 5, the visual navigation control interface 20 of the electronic device 2 has a plurality of user screen display areas 21 for simultaneously displaying a plurality of virtual reality display screens 12 of the reality display devices 1 worn by the users respectively, and the commentator may move the screen to watch the virtual reality display screens 12 watched by different users, or the visual navigation control interface 20 has a single user screen display area 21, and at least one switching key 25 disposed on a side of user screen display area 21 and provided for the commentator to click the switching key 25 and allow the user screen display area 21 to switch to a virtual reality display screen 12 watched by different users, so that the commentator can perform a narration to a plurality of users at the same time to achieve the effect of saving time. It is noteworthy that any other modification or variation of equivalent structures should be included in the scope of the present invention.

The electronic device 2 further has a control module 26 (using a press key to indicate a switch of function, but the invention is not limited to such arrangement) for controlling whether a screen displayed by the reality display device 1 controls the electronic device 2 or is controlled by the reality display device 1. When the control module 26 is turned on, the user may compulsorily control the screen displayed by the reality display device 1 through the electronic device 2, so that the commentator can let the user see the intended virtual reality display screen 12 easily. Now, the electronic device 2 transmits the display coordinates to a server, and the server sends the display coordinates to the virtual reality display device for display. When the commentator turns off the control module 26, the user may move and watch anywhere freely without being controlled by the commentator. Now, the screen coordinate position watched by the user will be returned to the server, and the screen will be displayed by the electronic device 2 synchronously. The control module 26 may control a plurality of reality display devices 1 to follow the commentator or move freely to anywhere.

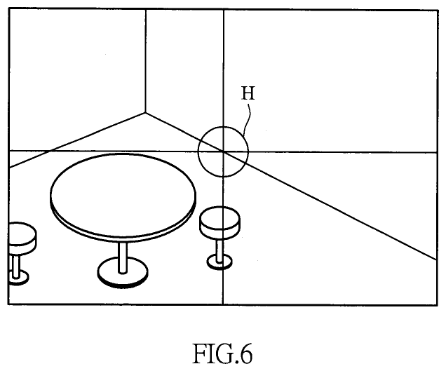

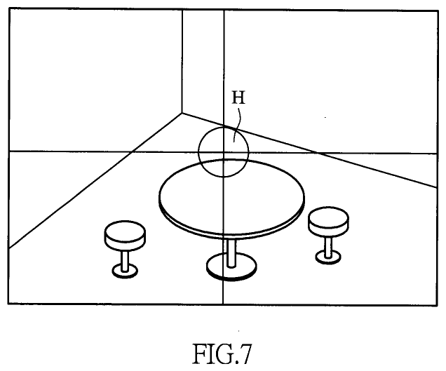

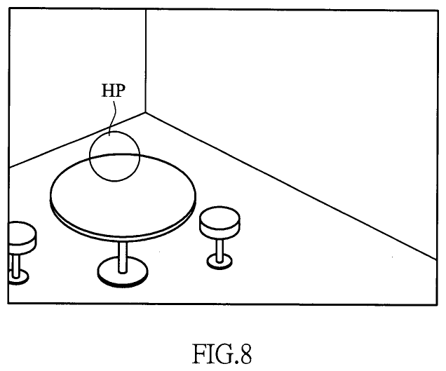

In addition, the hot point of the present invention may be created by the following method. In FIGS. 6 and 7, a hot point creation mode is entered, and a hot point H will be displayed on the display device (such as a display device of the electronic device) once the hot point H is set. The position of the set hot point H with respect to the display device remains unchanged. The user controls a scene screen displayed by the display device to move (FIG. 7 shows the movement made with respect to the situation as shown in FIG. 6). Confirmation is made after the scene screen position of a hot point HP to be set is configured to be corresponsive to the hot point H to be set. After a message and a scene path (such as a website) are inputted, and a hot point HP is set in the scene screen (by clicking the hot point H to be set), the hot point HP will be moved with the screen, and finally fixed to a specified position according to the setting as shown in FIG. 8. The present invention provides a more intuitive setting method to facilitate setting and operating a touch screen and improve the convenience of use.

Further, the hot point H to be set is set at the center of the screen displayed by the display device to facilitate the user to perform an intuitive operation, particularly for the operation of a touch screen.

The present invention further provides a method of synchronously connecting to a scene, and the method is provided for an electronic device 2 and at least one reality display device 1 to perform a synchronous screen display through a server, and this method comprises the following steps: The electronic device 2 sends a start instruction to the server, and the server returns a website to the electronic device 2. After the reality display device 1 inputs the website and enters into the website, a specified code included in the web site is transmitted to the server for comparison. After the comparison is confirmed without error, the reality display device 1 will display the screen displayed by the electronic device 2 to achieve the synchronization effect.

After the operation is completed, the server changes the website or the specified code in the website or website automatically, so that the users cannot enter and view the website through the same path, and a safe security effect is achieved.

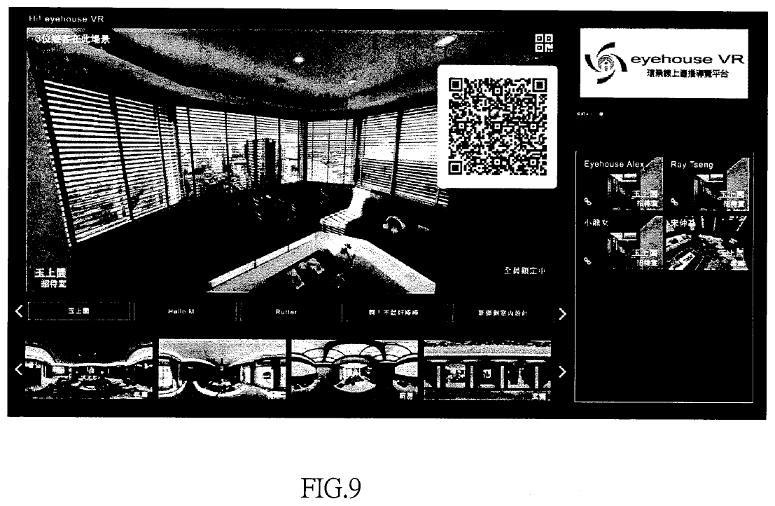

In addition, the electronic device 2 may have a quick response matrix conversion module for converting the received website into a quick response code (QR code), and the reality display device 1 has a quick response code reading module as shown in FIG. 9, and the quick response code reading module is provided for reading the quick response code displayed by the electronic device. Therefore, the chance of entering a wrong website can be reduced, or NFC equipments and/or functions may be integrated to send the web site to the reality display device 1 quickly.

In summation of the description above, the virtual reality real-time visual navigation system of the present invention definitely achieves the expected effects and objectives, and complies with patent application requirements, and thus is duly filed for patent application.

What is claimed is:

1. A virtual reality real-time visual navigation method, transmitting data through a reality display device, an electronic device and a server, characterized in that the reality display device receives an image of one of a plurality of locations stored in the server from the server and performs a virtual reality play, and synchronously displays a screen displayed by the reality display device on the electronic device, and the electronic device simultaneously performs a signal connection with the plurality of reality display devices, while displaying a screen displayed by the connected reality display devices,
wherein the electronic device has a visual navigation control interface installed thereto and capable of controlling a location displayed by the reality display devices,
wherein the reality display device sends a coordinate position of the displayed screen to the server, and the electronic device performs a corresponsive display after obtaining the coordinate position from the server;
wherein the screens have at least one hot point set thereon, and a user may jump to an image of a related location by selecting the hot point by the reality display device or the electronic device;
the hot point is set by the following step: an unset hot point shows on a display when entering a hot point establishing mode, and the position of the unset hot point with respect to the display device remains unchanged, a user can control a scene displayed by the display device to move to be corresponsive to the unset hot point, and confirm to set the hot point.

2. The virtual reality real-time visual navigation method of claim 1, wherein the reality display device includes a focus detection module installed thereto and provided for detecting a focus watched by a user's eye and displaying a focus position on a screen displayed by the electronic device.

3. The virtual reality real-time visual navigation method of claim 1, wherein the screen displayed by the reality display device or the screen displayed by the electronic device includes a user representative icon entering into the same scene.

4. The virtual reality real-time visual navigation method of claim 1, wherein the electronic device further includes a control module for controlling whether a screen displayed by the reality display device controls the electronic device or the screen displayed by the reality display device is controlled by the electronic device.

5. A virtual reality real-time visual navigation system, performing a signal conduction through a server by at least one reality display device and a visual navigation control interface installed in an electronic device, characterized in that the reality display device is worn by a user and provided for displaying a site specified by the visual navigation control interface, and an image played by the reality display device is synchronously played by the electronic device, and each reality display device plays a virtual reality display screen;
the electronic device includes a visual navigation control interface, and the visual navigation control interface includes at least one user screen display area for synchronously displaying the virtual reality display screen played by each reality display device;
wherein the visual navigation control interface of the electronic device has a plurality of user screen display areas for simultaneously displaying a plurality of virtual reality display screen of the reality display devices worn by the users;
wherein the visual navigation control interface has a hot point sign disposed in at least one user screen display area and configured to be corresponsive to the virtual reality display screen, and a user may use the visual navigation control interface or the reality display device to select the hot point sign in order to open another screen; and the at least one reality display device has a loudspeaker, and the electronic device has a microphone and a camera, and audio data are captured by the microphone and played by the loudspeaker; the visual navigation control interface of the electronic device has a plurality of users screen display area for simultaneously displaying and controlling a plurality of virtual reality display screens of the reality display devices worn by the users.

6. The virtual reality real-time visual navigation system of claim 5, wherein the reality display device includes a focus detection module for detecting a user's eye focus, and displaying focus mark corresponsive to the user's eyes focus position in each user screen display area.
